(19) United States
(12) Patent Application Publication
(10) Pub. No.: US 2013/0333119 A1
(43) Pub. Date: Dec. 19, 2013

(54) Hand-held tool for storing, measuring, cutting, and heat sealing paracord

(71) Applicant: Russell Maynard, San Diego, CA (US)

(72) Inventor: Russell Maynard, San Diego, CA (US)

(21) Appl. No.: 13/916,565

(22) Filed: Jun. 12, 2013

Related U.S. Application Data
(60) Provisional application No. 61/659,260, filed on Jun. 13, 2012.

(51) Int. Cl. B25F 1/00

(52) U.S. Cl. CPC B25F 1/00
USPC 7/163

(57) ABSTRACT

A hand-held tool for storing, measuring, cutting, and heat sealing paracord or other cord includes a spool having a plurality of cord-attachment apertures that attach to the sections of cord, a spooling hub onto which the sections of cord can be wound for storage, and two retaining flanges to help guide and retain the sections of cord when wound onto the spool; a cutting blade and blade guard near a first side of the device for cutting the cord; a lighter clip near a second side of the device having a plurality of flanges adapted to hold a cigarette lighter, the second side being generally opposite the first side; a ruler at the first side; a plurality of burn slots, each having a differently-sized burn slot aperture and a channel leading from the burn slot aperture to a side of the device; and a lanyard.

### RELATED APPLICATIONS

This application claims the benefit of the filing date of U.S. Patent Application No. 61/659,260, filed Jun. 13, 2012, which is incorporated herein by reference in its entirety.

### BACKGROUND OF THE INVENTION

The present invention generally relates to hand-held tools and more specifically to hand-held tools for use with paracord.

Paracord includes a variety of lightweight, substantially nylon rope, string, twine, or wire, having an interior core protected by a woven, external sheath, which can be used as a general purpose utility cord. “550 paracord” generally can support weights of up to 550 pounds.

Because it is made of nylon, an end of a length of frayed paracord may be melted to form a sealed end which will not unravel. If such a cord were to be inserted through a fixed-size aperture, such as a shoelace hole for a shoe, it would be desirable for the cord to have a consistent diameter so that it will fit and smoothly pass through the aperture.

Paracord can be stored in a loop, but it tangles easily in your gear. Shorter loops with more windings may tangle less easily, but would also be slow to wind and rewind. Precut sections of cord may be used, but if longer rope is needed, sections must be joined or knotted together.

Currently, separate tools are used for storing and working paracord or other cord that is melted to form a sealed end. Multiple tools may be bulky to carry and easy to misplace.

Current tools for spooling cord do not have burn slots to safely and cleanly heat seal the cut ends of paracord. Melted ends of cord will not necessarily be sealed with the same diameter as the cord. If the cord has a glob of nylon at one end, the cord will not perform properly, e.g., it will not fit when a user attempts to slide the cord through an aperture or grommet. Further, if the still-hot melted nylon is not properly handled, the hot material may stick to or damage other objects before it cools.

It would be desirable to have an all-in-one tool that is compact and easy to carry, having all the elements necessary to work paracord.

### SUMMARY OF THE INVENTION

In one aspect of the present invention, a device for use with a cord includes a spool around which the cord can be wound so as to retain the cord; a cutting blade near a first side of the device for cutting the cord; a lighter clip near a second side of the device for holding a fire starting tool, the second side being generally opposite the first side; a ruler; and a burn slot having an aperture with a diameter and a channel leading from the aperture to a side of the device, the channel being narrower than the diameter of the aperture.

In another aspect of the present invention, a device for use with sections of cord includes a spool having a plurality of cord-attachment apertures that attach to the sections of cord, a spooling hub onto which the sections of cord can be wound for storage, and two retaining flanges to help guide and retain the sections of cord when wound onto the spool; a cutting blade and blade guard near a first side of the device for cutting the cord; a lighter clip near a second side of the device having a plurality of flanges adapted to hold a cigarette lighter, the second side being generally opposite the first side; a ruler at the first side; and a plurality of burn slots, each having a differently-sized burn slot aperture and a channel leading from the burn slot aperture to a side of the device.

In yet another aspect of the present invention, a method of working cord includes providing a tool that includes a spool, a cutting blade, a removable cigarette lighter, and a burn slot; attaching a first end of the cord to the spool; winding the cord around the spool; unwrapping a section of cord from the spool; pulling the section of cord along an edge of the cutting blade, thereby cutting the cord and producing a second, frayed end of the section of cord; placing the section of cord in the burn slot; utilizing the cigarette lighter to melt the second, frayed end of the cord; and pulling the cord through the burn slot before the cord cools and hardens, thereby heat-sealing the second end of the cord.

### BRIEF DESCRIPTION OF THE DRAWINGS

FIG. 1 depicts a top view of an embodiment of the present invention;

FIG. 2 depicts a perspective view of the embodiment of FIG. 1; and

FIG. 3 depicts a top view of the embodiment of FIG. 1.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

An embodiment of the present invention generally provides a hand-held tool for storing, measuring, cutting, and heat sealing paracord. Embodiments may provide an all-in-one tool that may be compact and relatively easy to carry, having all the elements necessary to work paracord. Embodiments may incorporate a blade edge for safely cutting the cord, a retaining clip to hold a lighter, a six-inch ruler for measuring the cord, and burn slots to safely and cleanly heat seal the cut ends of the cord. Embodiments may be approximately 6.5″ by 3.5″, and may store different types of cord on one tool. Embodiments may be small enough to fit in a pocket or backpack, yet big enough to hold 100 feet of cord, preferably 150 feet.

Embodiments may spool parachute-type cords to prevent tangling. The term “paracord” as used herein may refer to 550 paracord, parachute cord, string, twine, cable, nylon rope, polypropylene rope, or other cord that can be melted at one end to form a seal.

In an embodiment, a spool holds the wrapped paracord, a ruler measures the cord, and a blade cuts the cord. A clip holds the lighter used to melt the cut ends. The burn slots hold various sizes of paracord either before or after the cord is melted, and then properly size the melted ends when the paracord is pulled through the slot. A lanyard hole allows the tool to be attached and suspended from clothing, a harness, or pack for one-handed cutting.

In an embodiment, “V” shaped slots store the wrapped paracord to prevent tangling. The lanyard hole allows the option of the tool being suspended from clothes, harness or pack for one-handed manipulation.

Embodiments may be machined or formed from plastic, metal, or ceramic, or may preferably be made with injection-molded plastic. The tool may be made of a single piece, or multiple pieces attached together.

Alternate embodiments may include a compass, an LED light, a whistle, a magnifying glass, or a storage area, etc. These elements may be built into the tool to increase its versatility as an outdoor/survival tool. Embodiments may come packaged with one or more lengths of cord having diameters that match the burn slot apertures.

In various embodiments, the blade can be replaceable or non-replaceable. The tool can be one-piece or multiple pieces fastened together. A lighter could be provided with the tool, or obtained separately. The size of the tool, and consequently the amount of cord it holds, could be adjusted for more or less cord storage. The arms or retaining flanges, which form the “V” slots to hold the wrapped paracord, could be fixed or adjustable to extend longer or retract shorter. The tool could have buoyancy pockets in it to enable it to float in water.

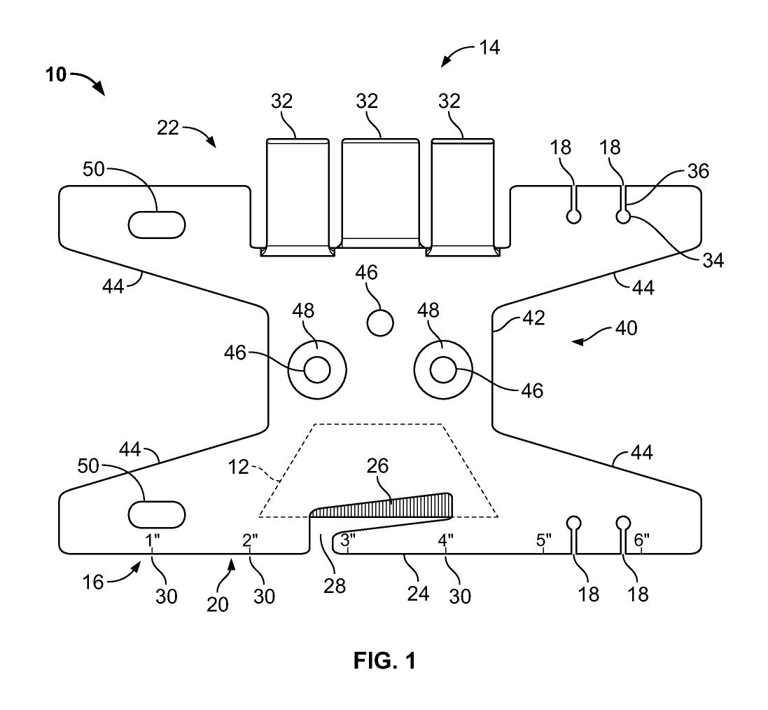

As depicted in FIG. 1, an embodiment of a cord handling tool 10 may include a cutting blade 12, a lighter clip 14, a ruler 16, one or more burn slots 18, and an integrated spool 40 to neatly hold one or more lengths of paracord.

Cutting blade 12 may be located on a cutting side 20 of the tool 10, and lighter clip 14 may be located on a clip side 22 generally opposite cutting side 20.

Cutting side 20 may have a blade guard 24 that helps protect against accidental damage caused by the cutting edge 26 of the blade 12. Cutting blade 12 may be a removable utility blade such as standard-sized blades used in box cutters. A cutting slot 28 adjacent to the blade guard 24 allows the user to pass cord past the blade guard 24 and onto the cutting edge 26 and safely cut the cord. In an embodiment, cutting blade 12 may be replaced by opening or removing a side cover.

Ruler 16 may include ruled markings 30 along the cutting side 20 to measure the cord to be cut. An example of ruled markings 30 may include 6 numbered marks one inch apart, with additional markings between the numbered marks that indicate fractions of an inch (such as ½ inch, ¼ inch, etc.) Embodiments may include metric marks that indicate centimeters and millimeters. Rule 16 may be on the cutting side 20, so that it is near to the cutting blade 12, and the user will not need to move the cord very far after measuring in order to cut.

Lighter clip 14 may include 3 or more clip flanges 32 at the clip side 22 of the tool 10. The flanges 32 may securely grasp a fire starting tool, such as a disposable cigarette lighter. One of the flanges 32 may extend out and above the lighter, and the other two flanges may extend out and below the lighter, so that the three alternating flanges 32 cooperate to releasably grasp and retain the lighter when it is inserted into the lighter clip 14.

One or more burn slots 18 may be located on the cutting side 20 or clip side 22 or both. Each burn slot 18 may include a round aperture 34, which passes through the tool 10, and a burn slot cord channel 36, which is an opening from the aperture 34 to the side of the tool 10 that allows the user to pass paracord through the channel 36 and into the aperture 34. The channel 36 may be narrower than the corresponding aperture 34 so that the user may slightly compress the sides of the cord to pass it through the channel, and then the uncompressed cord will fit the aperture 34. The user may then melt one end of the paracord and then pull the cord out through the burn slot 18, thereby shaping the partially-melted cord. Embodiments may include a plurality of burn slots, such as 4, each having a differently-sized aperture to be used with different diameters of paracord. The cords can be pulled through the appropriate burn slots to remove excess material from sides of the cords.

Spool 40 may have a spooling hub 42, around which the cord is wound, and retaining flanges 44 that form “V” shaped slots to help guide and retain the cord when it is wound onto the spool 40. The retaining flanges 44 extend out from sides that are adjacent and between the cutting side 20 and clip side 22 so that the cord may be wound around the spooling hub 42 around its sides and not interfere with the lighter clip 14 or cutting blade 12. A plurality of cord-attachment holes 46 near the center of the tool 10 may allow an end of the cord to be passed through the hole 46 and knotted so that the spool 40 will securely retain the end of cord. After the end of the cord is retained in the hole 46, the rest of the cord may be wound around the spooling hub 42. One or more cord-attachment holes 46 may further have an indented area 48 around the hole 46 so that the knot tied in the end of the cord will be securely cradled in the indented area 48. The spool 40 may hold different types of sizes of cord at the same time.

Embodiments of a tool 10 may further one or more lanyard holes 50 that can be used to attached a lanyard or other rope to conveniently carry the tool 10. A lanyard hole 50 may be on the line of the edge of the cutting blade 12, to facilitate one-handed cutting.

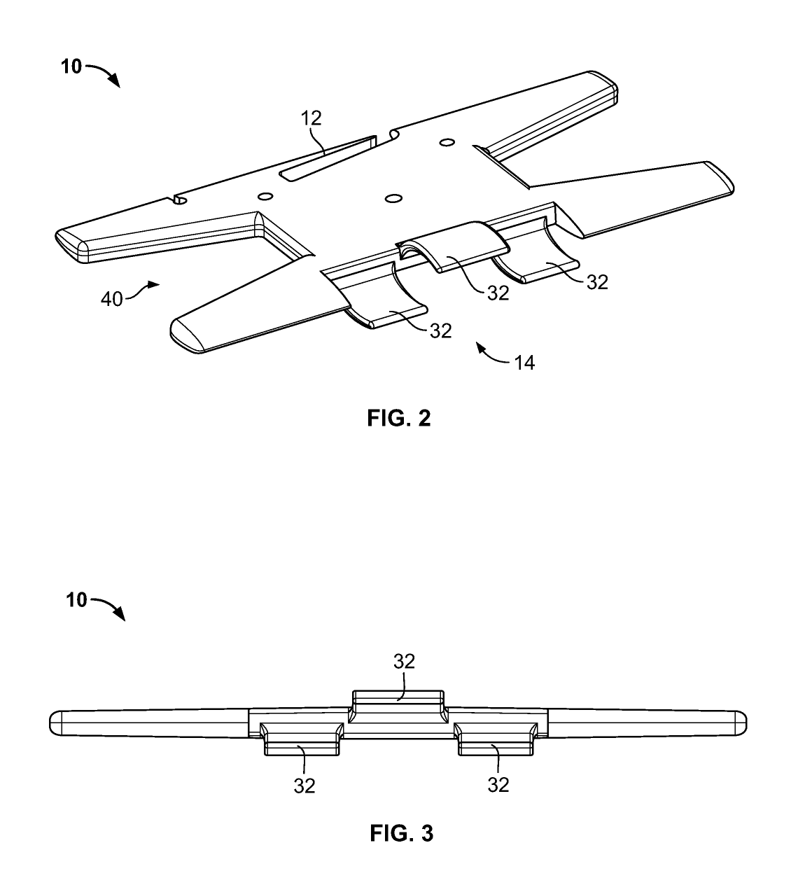

FIG. 2 depicts a perspective view of an embodiment of a cord handling tool 10. A cigarette lighter may be placed and stored between the clip flanges 32 of the lighter clip 14. When cord is wrapped around the spool 40, the cord will not interfere with the lighter clip 14 or cutting blade 12.

FIG. 3 depicts a top view of an embodiment of a cord handling tool 10. The clip flanges 32 alternate, so that some are above the lighter and some below, thereby retaining the lighter.

To use an embodiment, a length of paracord is threaded through one of the central holes in the tool, and a knot is tied to hold the end. The paracord then is spooled around the central “V” shaped slots for storage. The tool can be attached via a lanyard to clothes, harness or pack, or carried in a pocket/pouch. The paracord is unwrapped as needed and measured against the built-in ruler. The paracord is pulled along an edge of the recessed blade to cut it. The paracord end is slide through a channel into one of the matching sized burn slots, with perhaps 1″ of cord exposed. The lighter is pulled from the clip and used to melt the cut frayed end of the paracord. The paracord is then pulled through the burn slot to extinguish the flame and properly shape a heat-sealed end before it cools and hardens. Additionally, the tool and paracord could be used as a field-expedient tourniquet.

I claim:

1. A device for use with a cord, comprising
a spool around which the cord can be wound so as to retain the cord;
a cutting blade near a first side of the device for cutting the cord;
a lighter clip near a second side of the device for holding a fire starting tool, the second side being generally opposite the first side;
a ruler; and
a burn slot having an aperture with a diameter and a channel leading from the aperture to a side of the device, the channel being narrower than the diameter of the aperture.

2. The device of claim 1, wherein the spool has a cord-attachment aperture to which the cord can be attached, a spooling hub onto which the cord can be wound for storage, and two retaining flanges to help guide and retain the cord when it is wound onto the spool.

3. The device of claim 1, wherein the spool has a plurality of cord-attachment apertures so that multiple sections of cord can be wound onto the same spool.

4. The device of claim 1, wherein the spool has a cord-attachment aperture with an indented area around the aperture so that, if an end of the cord is passed through the aperture and a knot is tied in the end of the cord, the knot will be cradled in the indented area.

5. The device of claim 1, further comprising a blade guard on the first side of the device that partially blocks access to the cutting blade and forms a cutting slot so that the cord may be passed through the cutting slot and onto the cutting blade, thereby cutting the cord

6. The device of claim 1, wherein the cutting blade is a replaceable utility blade

7. The device of claim 1, wherein the lighter clip includes at least 3 flanges adapted to alternately pass above and below a cigarette lighter, so that the flanges cooperate to releasably retain the cigarette lighter

8. The device of claim 1, wherein the ruler has ruled markings at the first side of the device so that the cord may be measured and cut utilizing the first side

9. The device of claim 1, further comprising a plurality of burn slots having differently-sized apertures to be used with different diameters of cord

10. The device of claim 1, further comprising a lanyard hole that is located substantially on the same line as a cutting edge of the cutting blade

11. The device of claim 1, further comprising a length of cord having a diameter that is substantially similar to the diameter of the burn slot aperture, so that the length of cord can be pulled through the aperture and remove excess material from sides of the length of cord.

12. The device of claim 1, further comprising from 100 feet to 150 feet of paracord, wherein the paracord fits and smoothly passes through the burn slot aperture.

13. A device for use with sections of cord, comprising
a spool having a plurality of cord-attachment apertures that attach to the sections of cord, a spooling hub onto which the sections of cord can be wound for storage, and two retaining flanges to help guide and retain the sections of cord when wound onto the spool;
a cutting blade and blade guard near a first side of the device for cutting the cord;
a lighter clip near a second side of the device having a plurality of flanges adapted to hold a cigarette lighter, the second side being generally opposite the first side;
a ruler at the first side; and
a plurality of burn slots, each having a differently-sized burn slot aperture and a channel leading from the burn slot aperture to a side of the device.

14. The device of claim 13, further comprising an indented area around one of the cord-attachment apertures so that a knot tied in the section of cord attached to said one cord-attachment aperture will be cradled in the indented area.

15. The device of claim 13, further comprising a lanyard hole that is located substantially on the same line as a cutting edge of the cutting blade.

16. A method of working cord, comprising:
providing a tool that includes a spool, a cutting blade, a removable cigarette lighter, and a burn slot;
attaching a first end of the cord to the spool;
winding the cord around the spool;
unwrapping a section of cord from the spool;
pulling the section of cord along an edge of the cutting blade, thereby cutting the cord and producing a second, frayed end of the section of cord;
placing the section of cord in the burn slot;
utilizing the cigarette lighter to melt the second, frayed end of the cord; and
pulling the cord through the burn slot before the cord cools and hardens, thereby heat-sealing the second end of the cord.

17. The method of claim 16, wherein the step of attaching the first end of the cord to the spool further comprises:
threading the first end of the cord through a cord-attachment aperture on the spool;
tying a knot in the cord; and
cradling the knot in an indented area of the cord-attachment aperture.

18. The method of claim 16, wherein the step of placing the section of cord in the burn slot further comprises:
sliding the section of cord through a channel at a side of the tool into an aperture of the burn slot, the channel having a narrower width than a diameter of the aperture so that the cord is compressed to slide through the channel, and after being placed, the uncompressed diameter of the cord fits the diameter of the aperture.

19. The method of claim 16, further comprising:
before cutting the cord, utilizing a ruler on a side of the tool to measure the section of cord to be cut.

20. The method of claim 16, further comprising:
attaching a lanyard to a lanyard hole of the tool, the lanyard hole being located in alignment with a cutting edge of the cutting blade;
hanging the tool from the lanyard; and
utilizing one hand of a user to cut the cord.
